(19) United States
(12) Patent Application Publication
(10) Pub. No.: US 2015/0286990 A1
(43) Pub. Date: Oct. 8, 2015

(54) SOCIALLY AUGMENTED JOB APPLICATIONS

(71) Applicants: Timothy Adair, Minneapolis, MN (US); Paul Vassar, Maple Plain, MN (US)

(72) Inventors: Timothy Adair, Minneapolis, MN (US); Paul Vassar, Maple Plain, MN (US)

(73) Assignee: SuccessFactors, South San Francisco, CA (US)

(21) Appl. No.: 14/244,822

(22) Filed: Apr. 3, 2014

(51) Int. Cl. G06Q 10/10; G06Q 50/00

(52) U.S. Cl. CPC G06Q 10/1053; G06Q 50/01

(57) ABSTRACT

Methods and apparatus, including computer program products, are provided completing job-applications on-line. In some example implementations, there is provided a method including receiving, at a recruitment marketing server, an indication of an authorization to access candidate profile data from a social media website including the candidate profile data; obtaining, by the recruitment marketing server in response to the received indication, the candidate profile data from the social media website; and providing, by the recruitment marketing server, the obtained candidate profile data and metadata about the obtained candidate profile data to an applicant tracking server to allow the applicant tracking server to track a job application being completed using one or more portions of the obtained candidate profile data mapped, based on the metadata, to one or more portions of the job application. Related systems and articles of manufacture are also discloses.

### FIELD

The present disclosure generally relates to processes for managing employee hiring.

### BACKGROUND

Today, businesses rely on business enterprise resource planning (“ERP”) and other types of business systems to assist them in performing various tasks as well as allowing them to run smoothly. The day-to-day operations may include a multitude of tasks, such as purchasing, selling, distribution, payroll, accounting, benefits, security, maintenance, and various other tasks that businesses need to stay afloat in a dynamic marketplace. The systems, solutions, and other software that may perform these tasks may come from different vendors and/or designed using different computing platforms, frameworks, and the like (for example, programming languages, operating environments, etc.). As such, in order for businesses to have full and uninterrupted uses of their ERP systems, solutions, and other software, it is desirable that such ERP systems, solutions, and other software be compatible with one another, while being adaptable to the ever-changing way business is conducted.

### SUMMARY

Methods and apparatus, including computer program products, are provided completing job applications on-line.

In some example implementations, there is provided a method including receiving, at a recruitment marketing server, an indication of an authorization to access candidate profile data from a social media website including the candidate profile data; obtaining, by the recruitment marketing server in response to the received indication, the candidate profile data from the social media website; and providing, by the recruitment marketing server, the obtained candidate profile data and metadata about the obtained candidate profile data to an applicant tracking server to allow the applicant tracking server to track a job application being completed using one or more portions of the obtained candidate profile data mapped, based on the metadata, to one or more portions of the job application.

In some implementations, the above-noted aspects may further include additional features described herein including one or more of the following. The received indication may include at least one credential of a job applicant to enable a login into the social media website on behalf of the job applicant. The obtaining may further include accessing, by the recruitment marketing server after the login, the candidate profile data stored at the social media website and corresponding to the job applicant. The metadata may include information describing the mapping from the one or more portions of the obtained candidate profile data to the one or more portions of the job application. The metadata may include at least one user preference for the mapping form the one or more portions of the obtained candidate profile data to the one or more portions of the job application. The one or more portions of the obtained candidate profile data may be mapped to the one or more portions of the job application. A portion of the mapped job application may be provided to a user equipment to allow completion of the mapped job application. In response to the provided portion of the mapped job application, at least one of an edit indication or an accept indication may be received. The recruitment marketing server may be coupled via a network to the applicant tracking server and the social media website.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1 depicts an example of a system for pulling candidate profile data from a social media source, in accordance with some example implementations;

FIG. 2 depicts an example of a page at which a certain job posting may be selected, in accordance with some example implementations;

FIG. 3 depicts an example of a page at which a job applicant allows candidate profile data to be obtained from a social media source, in accordance with some example implementations;

FIG. 4 depicts an example of a page where a job applicant provides credentials to access the social media source, in accordance with some example implementations;

FIGS. 5-6 depict examples of candidate profile data and metadata to allow mapping the candidate profile data into a one or more fields of an on-line job application, in accordance with some example implementations; and

FIG. 7 depicts an example process for using candidate profile data to complete an on-line job application, in accordance with some example implementations;

Like labels are used to refer to same or similar items in the drawings.

### DETAILED DESCRIPTION

Human resource management systems may include recruitment marketing systems to allow one or more entities to market job positions to potential candidates. For example, a company may deploy a recruitment marketing system on its website, so that when a candidate goes to the website, the candidate can view positions and, if interested, apply for a job by filing an on-line application. With the advent of mobile computing, such as smart phones, tablets, and the like, requiring a job candidate to complete each and every field of a job application may not be practical given the limited display areas of some devices and limited/spotty data connectivity prevalent in some mobile wireless systems.

In some example embodiments, there may be provided a mobile application that allows a job candidate to navigate job listings provided by a recruitment marketing system and, when a position of interest is identified, complete a job application on-line using candidate profile data pulled from a social networking site, such as LinkedIn, Facebook, and/or any other third party website or third-party source of social media.

Moreover, the mobile application may allow the candidate to opt-in or authorize the candidate profile data pull, and may allow the candidate to approve or reject one or more portions of the candidate profile data pull being used in the application.

Furthermore, the pulled candidate profile data and metadata (which can be used to map the candidate profile data into fields of the job application) may, in some implementations, be provided by the recruitment marketing system to a back-end applicant tracking system (also referred to as a recruit tracking system) that tracks an candidate job applicant through the application completion process, interviewing process, evaluation process, and other tasks in the hiring workflow.

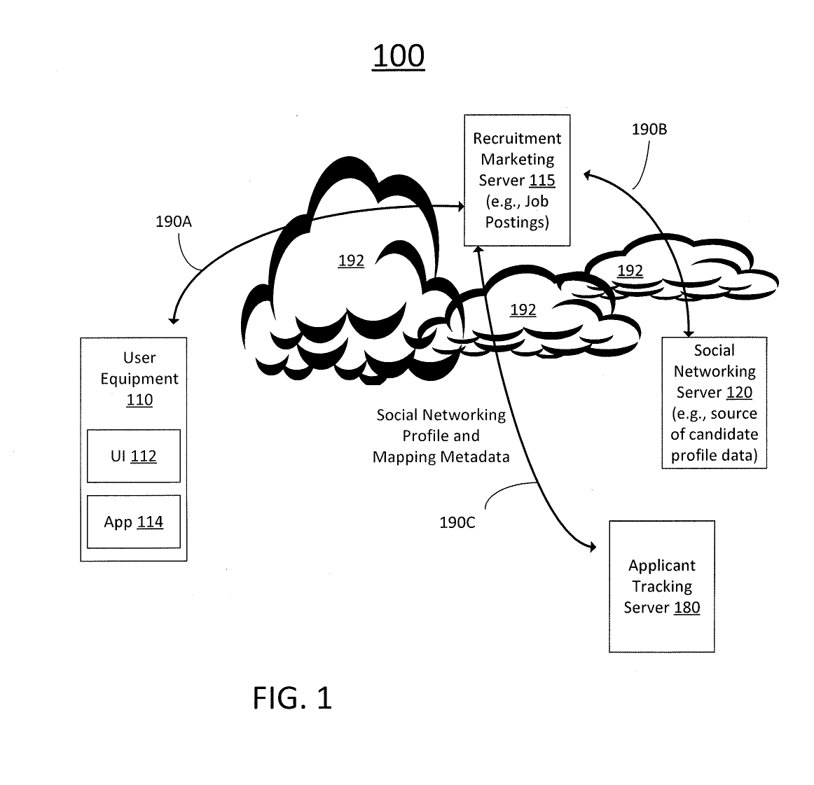

FIG. 1 depicts an example of a system 100 including a user equipment 110, such as a smartphone, tablet, and/or any other device, accessing at 190A a server 115, such as a recruitment marketing server 115, to view job postings. The user equipment 110 may include a mobile application 114, such as a browser, a job application mobile application, and the like, to provide interaction with server 115 via a user interface 112.

User equipment 110 may couple at 190A via wired and/or wireless connections to the recruitment marketing server 115 via one or more networks 192, such as the Internet, cellular network(s), and/or any other network. For example, user equipment 110 may access via the Internet a website including one or more job postings provided by recruitment marketing server 115.

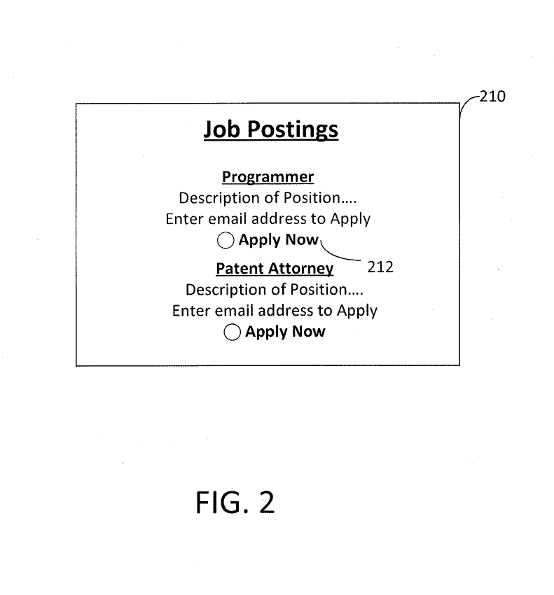

FIG. 2 depicts examples of job posting page, or view, 210 provided by recruitment marketing server 115. This page/view 210 may be presented by a user interface 112 of user equipment 110. A selection may be received at user interface 112 to indicate that a candidate applicant is interested in applying for a programmer position, for example. When this is the case, the user interface 112 may receive an indication that apply now 212 has been selected.

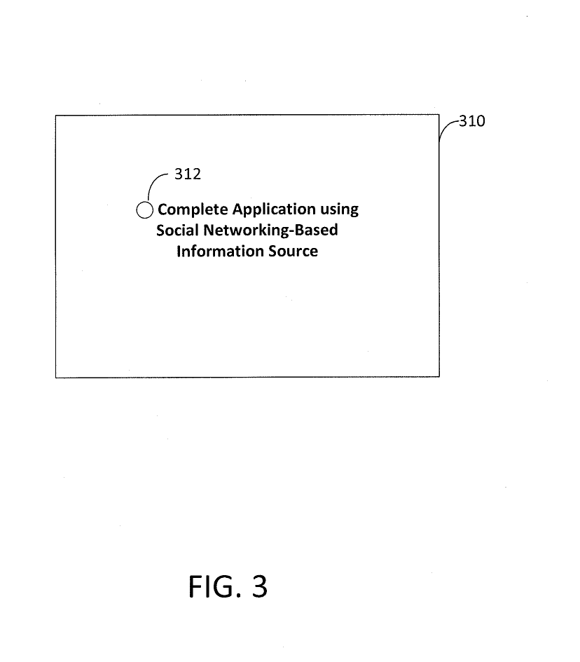

When apply now 212 is selected, page/view 310 depicted at FIG. 3 may be presented at the user interface 112. Page 310 may be generated by the mobile application 114 and/or provided by recruitment marketing server 115 to allow the job applicant to authorize access to social media sources of information. For example, if a selection is received 312 indicating that the job applicant enables social networking information to be accessed and thus used to complete the job application, then recruitment marketing server 115 may access at 190B a source of the social networking information, such server 120 and/or any other existing source of candidate profile data.

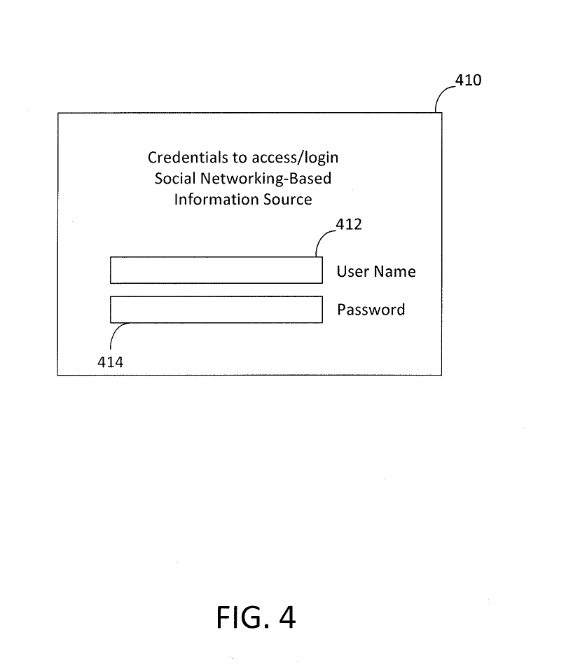

FIG. 4 depicts page 410, which may be presented at user interface 112 after 312 is selected to authorize recruitment marketing server 115 to access a source of social media/networking information, such as server 120. In the example of page 410, a user name 412 and password 414 are provided as credentials to gain access to the source of the social networking information at for example server 120. Using the credentials provided at 412 and 441, recruitment marketing server 115 may access a source of social networking information and obtain some (if not all) of the candidate profile data from the social networking source at server 120.

Once the candidate profile data is obtained from the social networking source/server 120, recruitment marketing server 115 may provide the candidate profile data to another server, such as backend candidate tracking server 180. Recruitment marketing server 115 may also provide to the server 180 metadata identifying the pulled candidate profile data. This metadata may allow the candidate tracking server 180 to map the candidate profile data to appropriate fields of the on-line job application.

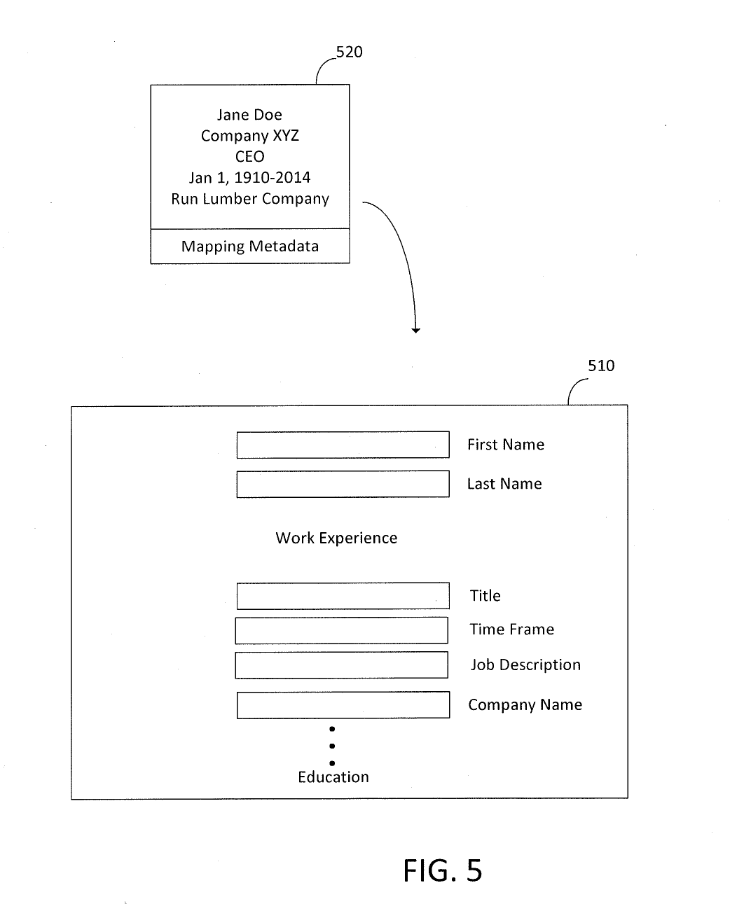

FIG. 5 depicts candidate profile data and corresponding metadata 520, which is provided at 190C to candidate tracking server 180. Candidate tracking server 180 may generate page 510 and/or provide page 510 (or the information therein) to user interface 112 at user equipment 110 for presentation, so that for example a job applicant can complete an on-line job application using the candidate profile data.

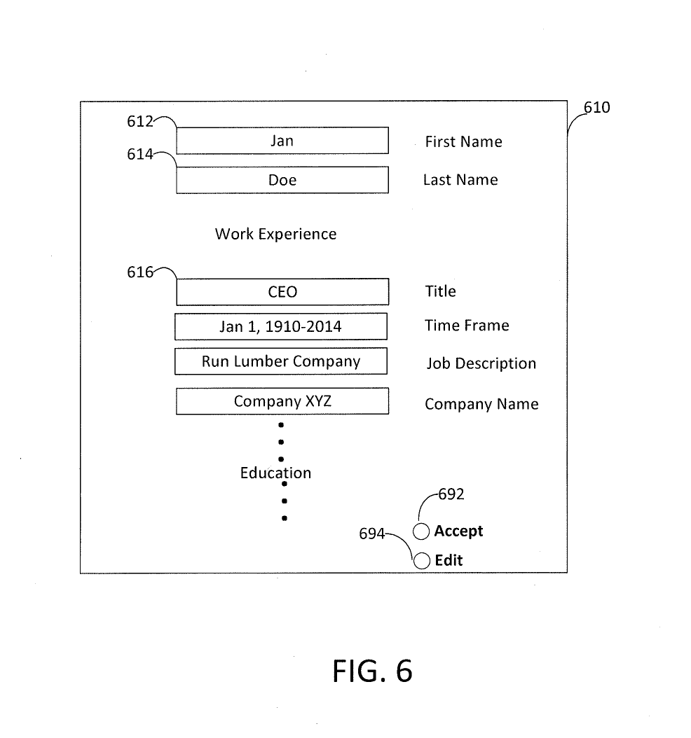

FIG. 6 depicts page 610, which represents page 510 with the candidate profile data and corresponding metadata 520 mapped into fields of a job application. In the example of FIG. 6, the profile data “Jane Doe” may have corresponding metadata describing the data as first name and last name, so that candidate tracking server 180 may map the profile data into fields 612 and 614 of the job application page 610. Similarly, the profile data “CEO” may have corresponding metadata describing the data as Title, so that candidate tracking server 180 may map the profile data into field 616. The generated page (or portions thereof) may be sent to user equipment 110 for presentation at user interface 112.

FIG. 6 also shows that quality control may be provided for the candidate profile data mapped into job application page 610. In the example of FIG. 6, a selection at user interface 112 of Accept 692 may accept the fields 612, 614, 615, and the job application page 610 can be submitted for processing in the workflow of candidate tracking server 180. However, an Edit 694 selection may indicate a change is desired to one or more fields, although after revision of a given field the change may be accepted and thus submitted for processing in the workflow of candidate tracking server 180.

From the perspective of user equipment 110, the workflow from recruitment marketing server 115, source of social networking information server 120, and candidate tracking server 180 may appear relatively seamless due to the integrated workflow between the recruitment marketing server 115, candidate tracking server 180, and social media server/website 120.

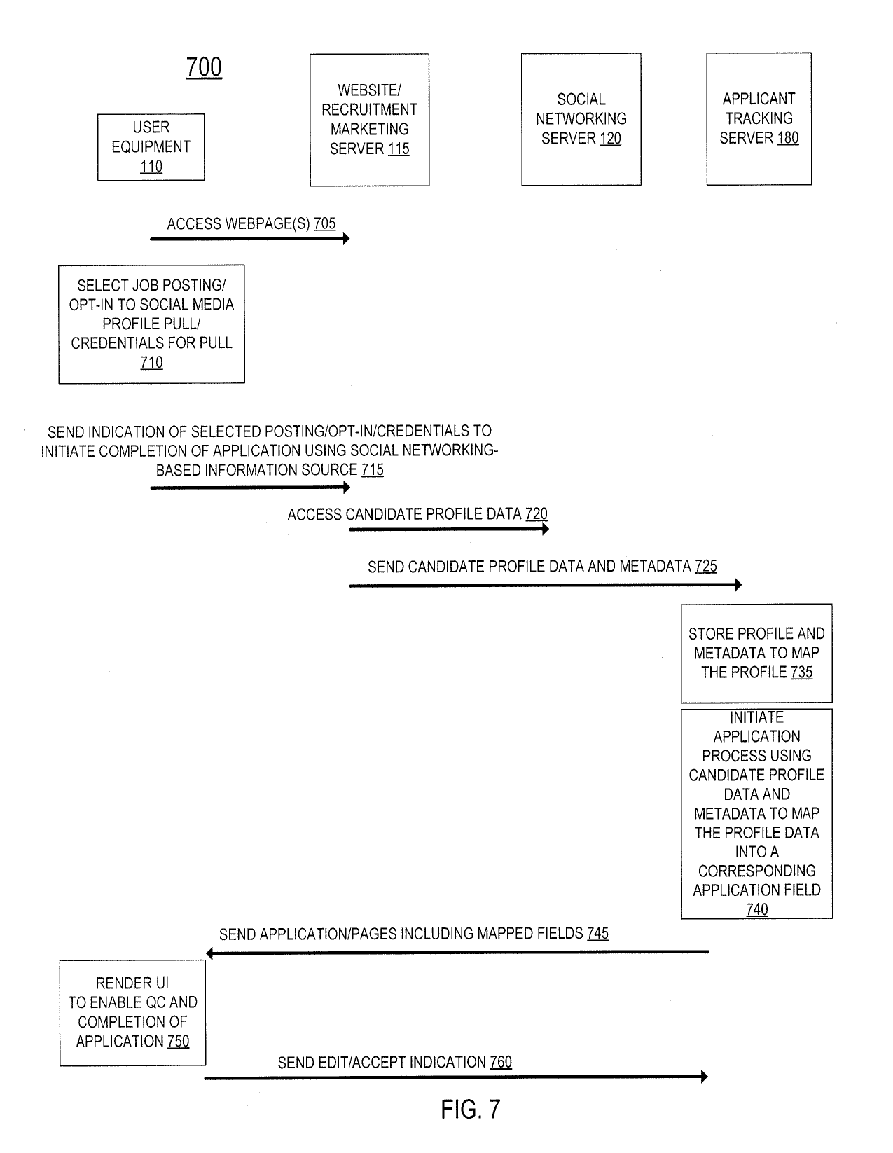

FIG. 7 depicts a process 700 for socially enabled job applications, in accordance with some example implementations. The description of process 700 also refers to FIGS. 1-6.

At 705, user equipment 110 may access one or more webpages. For example, user equipment 110 may access at 190A a website containing one or more job postings, such as the posting at page 210. The posting may be provided to the website by recruitment marketing server 115.

At 710, a selection may be received indicating a selection of a job posting, and this selection may initiate a job application process. Moreover, a selection may also indicate that candidate profile data may be pulled from a social media source/website. For example, a selection 212 may be made via a user interface to indicate interest in a job posting and a selection may also be made at 312 to authorize access of the candidate profile data at the social media-based sources of information, such as server 120. Moreover, credentials, such as login 412, password 414 and the like, may be received by user equipment 110/mobile application 114 to facilitate the access to server 120

At 715, mobile application 114 may send an indication to recruitment marketing server 115 of the selections made and/or credential provided to initiate the application process at recruitment marketing server 115. In response, recruitment marketing server 115 may access at 720 candidate profile data at one or more websites, such as social media server 120. Recruitment marketing server 115 may then provide at 725 the obtained candidate profile data and metadata to applicant tracking server 180. The applicant tracking server 180 may then store at 735 the candidate profile data and metadata, and then initiate at 740 tracking of the candidate at user equipment 110 by proceeding with the on-line job application process using the candidate profile data and metadata. Referring again to FIGS. 5 and 6, the candidate profile data and metadata may be mapped at 740 into portions (for example, fields) of the on-line job application being completed via user equipment 110.

At 745, applicant tracking server 180 may provide one or more pages/views, such as page 610 as well as other pages, to user equipment 110 for presentation. At 750, the user equipment 110 may render the page, such as page 610 and the like, for viewing at the user interface 112. The user equipment 110 may receive at 760 an indication of Edit 694 and/or Acceptance 694 of the candidate profile data mapped into the fields of the job application. In some example implementations, candidate profile data may be mapped to fields of the job applications based on user or client preferences. Once mapped, the mapping may be used for other applications associated with that specific user or client. The applicant track system 180 may provide additional pages as well including fields that have been tentatively filled-in using the candidate profile data, although applicant track system 180 can provide some of the pages without mapped candidate profile data (in which case the job applicant may have to complete one or more fields without the assistance of candidate profile data obtained from a third-party source).

From the perspective of user equipment 110, the job application process may appear seamless despite the various actors involved. Moreover, the use of candidate profile data may allow easier completion of at least portions of a job application.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

What is claimed:

1. A computer-readable medium containing instructions to configure at least one processor to cause operations comprising:
receiving, at a recruitment marketing server, an indication of an authorization to access candidate profile data from a social media website including the candidate profile data;
obtaining, by the recruitment marketing server in response to the received indication, the candidate profile data from the social media website; and
providing, by the recruitment marketing server, the obtained candidate profile data and metadata about the obtained candidate profile data to an applicant tracking server to allow the applicant tracking server to track a job application being completed using one or more portions of the obtained candidate profile data mapped, based on the metadata, to one or more portions of the job application.

2. The computer-readable medium of claim 1, wherein the received indication includes at least one credential of a job applicant to enable a login into the social media website on behalf of the job applicant.

3. The computer-readable medium of claim 2, wherein the obtaining further comprises:
accessing, by the recruitment marketing server after the login, the candidate profile data stored at the social media website and corresponding to the job applicant.

4. The computer-readable medium of claim 1, wherein the metadata includes information describing the mapping from the one or more portions of the obtained candidate profile data to the one or more portions of the job application.

5. The computer-readable medium of claim 4, wherein the metadata includes at least one user preference for the mapping from the one or more portions of the obtained candidate profile data to the one or more portions of the job application.

6. The computer-readable medium of claim 4 further comprising:
mapping the one or more portions of the obtained candidate profile data to the one or more portions of the job application.

7. The computer-readable medium of claim 6 further comprising:
providing a portion of the mapped job application to a user equipment to allow completion of the mapped job application.

8. The computer-readable medium of claim 7 further comprising:
receiving, in response to the provided portion of the mapped job application, at least one of an edit indication or an accept indication.

9. The computer-readable medium of claim 1, wherein the recruitment marketing server is coupled via a network to the applicant tracking server and the social media website.

10. A method comprising:
receiving, at a recruitment marketing server, an indication of an authorization to access candidate profile data from a social media website including the candidate profile data;
obtaining, by the recruitment marketing server in response to the received indication, the candidate profile data from the social media website; and
providing, by the recruitment marketing server, the obtained candidate profile data and metadata about the obtained candidate profile data to an applicant tracking server to allow the applicant tracking server to track a job application being completed using one or more portions of the obtained candidate profile data mapped, based on the metadata, to one or more portions of the job application.

11. The method of claim 10, wherein the received indication includes at least one credential of a job applicant to enable a login into the social media website on behalf of the job applicant.

12. The method of claim 12, wherein the obtaining further comprises:
accessing, by the recruitment marketing server after the login, the candidate profile data stored at the social media website and corresponding to the job applicant.

13. The method of claim 10, wherein the metadata includes information describing the mapping from the one or more portions of the obtained candidate profile data to the one or more portions of the job application.

14. The method of claim 13, wherein the metadata includes at least one user preference for the mapping from the one or more portions of the obtained candidate profile data to the one or more portions of the job application.

15. The method of claim 13 further comprising:
mapping the one or more portions of the obtained candidate profile data to the one or more portions of the job application.

16. The method of claim 15 further comprising:
providing a portion of the mapped job application to a user equipment to allow completion of the mapped job application.

17. The method of claim 16 further comprising:
receiving, in response to the provided portion of the mapped job application, at least one of an edit indication or an accept indication.

18. The method of claim 10, wherein the recruitment marketing server is coupled via a network to the applicant tracking server and the social media website.

19. A system comprising:
at least one processor; and
at least one memory including computer code which when executed by the at least one processor causes operations comprising:
receiving, at a recruitment marketing server, an indication of an authorization to access candidate profile data from a social media website including the candidate profile data;
obtaining, by the recruitment marketing server in response to the received indication, the candidate profile data from the social media website; and
providing, by the recruitment marketing server, the obtained candidate profile data and metadata about the obtained candidate profile data to an applicant tracking server to allow the applicant tracking server to track a job application being completed using one or more portions of the obtained candidate profile data mapped, based on the metadata, to one or more portions of the job application.

20. The system of claim 19, wherein the received indication includes at least one credential of a job applicant to enable a login into the social media website on behalf of the job applicant.
